(19) United States
(12) Patent Application Publication
(10) Pub. No.: US 2020/0233783 A1
(43) Pub. Date: Jul. 23, 2020

(54) TEST PATTERN GENERATION DEVICE

(71) Applicant: FANUC CORPORATION, Yamanashi (JP)

(72) Inventor: Yuusuke KOBAYASHI, Yamanashi (JP)

(21) Appl. No.: 16/743,010

(22) Filed: Jan. 15, 2020

(30) Foreign Application Priority Data
Jan. 22, 2019 (JP) 2019-008728

(51) Int. Cl. G06F 11/36

(52) U.S. Cl. CPC G06F 11/3684; G06F 11/3696

(57) ABSTRACT

A test pattern generation device that generates test input sequences for testing a sequence program calculates all possible states and state changes taken for each of input signals of the sequence program, generates test patterns in which each of the calculated state changes of the input signals is combined with the states or the state changes of another of the input signals, and generates the test input sequences on the basis of the generated test patterns.

### RELATED APPLICATIONS

The present application claims priority to Japanese Patent Application Number 2019-008728 filed Jan. 22, 2019, the disclosure of which is hereby incorporated by reference herein in its entirety.

### BACKGROUND OF THE INVENTION

### 1. Field of the Invention

The present invention relates to a test pattern generation device and, in particular, to a test pattern generation device capable of easily generating test patterns of a sequence program.

### 2. Description of the Related Art

A technology with which a source code (for example, the source code of a general-purpose computer program generated by programming language such as C/C++) is analyzed to automatically generate test patterns of the program has been known.

Although not relating to the generation of test patterns, Japanese Patent Application Laid-open No. 2007-206798 discloses a device capable of automatically generating a sequence program corresponding to a sequence diagram.

However, when a conventional technology for automatically generating test patterns for a general-purpose program is applied to a sequence program, consideration has to be given to a time series in the sequence program, which causes a problem that the numbers of test patterns and test input sequences become enormous. That is, in the sequence program, input signals possibly take a plurality of states at a certain time and possibly change the states for each time. In a case in which test patterns covering such a change in the input signals with the passage of time are generated, the number of the generated patterns becomes extremely enormous.

The problem will be described referring to FIG. 1. A sequence program with two signals A and B as inputs will be considered. It is assumed that both the signals A and B take either 0 or 1. There are 2×2=4 patterns of combinations of signals A and B possibly taken at a certain time. Further, the number of test patterns is the n-th power of 4 when a scan is performed n times in the sequence program. Generating such an enormous amount of test patterns is an operation requiring large labor and cost.

### SUMMARY OF THE INVENTION

The present invention has been made to solve the above problems and has an object of providing a test pattern generation device capable of easily generating test patterns of a sequence program.

A test pattern generation device according to an embodiment of the present invention generates test input sequences for testing a sequence program. The test pattern generation device includes: a state/state-change analysis unit that calculates all possible states and state changes taken for each of input signals of the sequence program; a test pattern generation unit that generates test patterns in which each of the state changes of the input signals is combined with the states or the state changes of another of the input signals; and a test input sequence generation unit that generates the test input sequences on the basis of the test patterns.

The test pattern generation device may further include a test input sequence reduction unit that deletes an overlapping test input sequence from the test input sequences.

The test input sequence generation unit may generate additional test input sequences by shifting a signal change timing of the generated test input sequences.

The test input sequence generation unit may generate additional test input sequences by joining a plurality of the generated test input sequences together.

According to an embodiment of the present invention, it is possible to provide a test pattern generation device capable of easily generating test patterns of a sequence program with the above configurations.

### BRIEF DESCRIPTION OF THE DRAWINGS

FIG. 1 is a diagram showing an example of a conventional test pattern generation method;

FIG. 2 is a hardware configuration diagram of test equipment including a test pattern generation device according to an embodiment of the present invention;

FIG. 3 is a block diagram showing the characteristic functional configurations of the test equipment shown in FIG. 2;

FIG. 4 is a diagram for illustrating analysis processing to analyze states and state changes of input signals by a state/state-change analysis unit shown in FIG. 3;

FIG. 5 is a diagram for illustrating test pattern generation processing by a test pattern generation unit shown in FIG. 3;

FIG. 6 is a diagram for illustrating test input sequence generation processing by a test input sequence generation unit shown in FIG. 3;

FIG. 7 is a diagram for illustrating the test input sequence generation processing by the test input sequence generation unit;

FIG. 8 is a diagram for illustrating the test input sequence generation processing by the test input sequence generation unit shown in FIG. 3;

FIG. 9 is a diagram for illustrating test input sequence reduction processing by a test input sequence reduction unit shown in FIG. 3;

FIG. 10 is a diagram for illustrating the test input sequence reduction processing by the test input sequence reduction unit shown in FIG. 3;

FIG. 11 is a diagram for illustrating the test input sequence generation processing by the test input sequence generation unit shown in FIG. 3;

FIG. 12 is a diagram for illustrating the test input sequence generation processing by the test input sequence generation unit shown in FIG. 3;

FIG. 13 is a diagram for illustrating analysis processing to analyze states and state changes of input signals by the state/state-change analysis unit shown in FIG. 3;

FIG. 14 is a diagram for illustrating the test pattern generation processing by the test pattern generation unit shown in FIG. 3;

FIG. 15 is a diagram for illustrating the test input sequence generation processing by the test input sequence generation unit shown in FIG. 3;

FIG. 16 is a diagram for illustrating the test input sequence generation processing by the test input sequence generation unit shown in FIG. 3;

FIG. 17 is a diagram for illustrating the test input sequence generation processing by the test input sequence generation unit shown in FIG. 3;

FIG. 18 is a diagram for illustrating the test input sequence reduction processing by the test input sequence reduction unit shown in FIG. 3;

FIG. 19 is a diagram for illustrating the test input sequence generation processing by the test input sequence generation unit shown in FIG. 3; and

FIG. 20 is a diagram for illustrating the test input sequence generation processing by the test input sequence generation unit shown in FIG. 3.

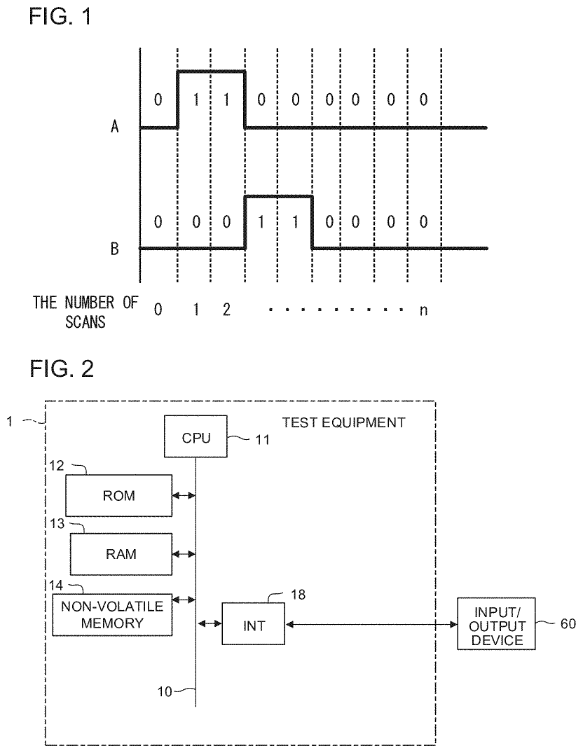

### DETAILED DESCRIPTION OF THE PREFERRED EMBODIMENTS

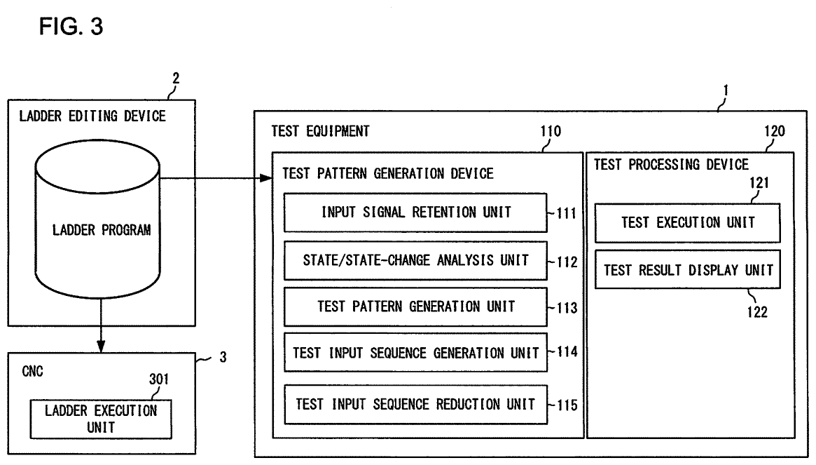

FIG. 2 is a schematic hardware configuration diagram showing the essential part of test equipment 1 including a test pattern generation device 110 (FIG. 3) according to an embodiment of the present invention.

The test equipment 1 is typically an information processing device such as a personal computer and a numerical controller and has a CPU 11, a ROM 12, a RAM 13, a non-volatile memory 14, a bus 10, and an interface 18. An input/output device 60 is connected to the test equipment 1.

The CPU 11 is a processor that entirely controls the test equipment 1. The CPU 11 reads a system program stored in the ROM 12 via the bus 10 and controls the entire test equipment 1 according to the system program.

The ROM 12 stores, for example, a system program in advance. The RAM 13 temporarily stores temporary calculation data or display data and data, a program, or the like input by an operator via the input/output device 60.

The non-volatile memory 14 is backed up by, for example, a battery not shown and retains its storage state even if the power supply of the test equipment 1 is interrupted. The non-volatile memory 14 stores data, a program, or the like input from the input/output device 60. The program or the data stored in the non-volatile memory 14 may be developed into the RAM 13 when executed and used.

The input/output device 60 is a data input/output device including a display, a keyboard, or the like and displays information received from the CPU 11 via an interface 18 on the display (not shown). The input/output device 60 supplies an instruction, data, or the like input from the keyboard to the CPU 11 via the interface 18.

FIG. 3 is a block diagram showing the characteristic functional configurations of the test equipment 1.

The test equipment 1 includes the test pattern generation device 110 and a test processing device 120. The test pattern generation device 110 and the test processing device 120 are typically mounted as logical processing units provided in the test equipment 1, but each of the devices may have independent hardware.

The test pattern generation device 110 has an input signal retention unit 111, a state/state change analysis unit 112, a test pattern generation unit 113, a test input sequence generation unit 114, and a test input sequence reduction unit 115.

The input signal retention unit 111 reads and analyzes a ladder program generated by a ladder editing device 2 and extracts one or more input signals with respect to the ladder program. Note that the ladder program is a typical example of a sequence program. However, the present embodiment is not limited to the ladder program, and the input signal retention unit 111 is capable of reading any sequence program.

The state/state-change analysis unit 112 calculates all possible states (values) and state changes for each of the input signals extracted by the input signal retention unit 111. Here, the state changes represent the characteristic concept of the invention of the present application, indicating a way in which the states of the input signals change with the passage of time.

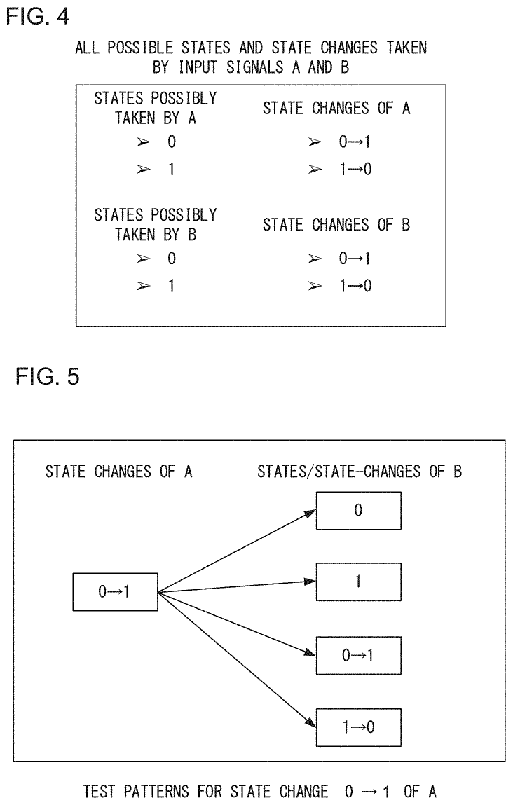

The states and state changes of the input signals will be specifically described using FIG. 4.

It is now assumed that there are two input signals A and B with respect to a sequence program, and that both the input signals possibly take either 0 or 1. In this case, the signal A possibly takes one of two states, i.e., 0 or 1. The signal B possibly takes one of two states, i.e., 0 or 1. Further, the signal A possibly changes to 1 when the state of the signal A is 0, and possibly changes to 0 when the state of the signal A is 1. These are the possible two state changes taken by the signal A. The signal B also possibly changes to 1 when the state of the signal B is 0, and possibly changes to 0 when the state of the signal B is 1. These are the possible two state changes taken by the signal B.

The test pattern generation unit 113 selects one of the input signals extracted by the input signal retention unit 111 and generates combinations (test patterns) of a state change of the selected signal and the states or state changes of the other signal. The generation of the combinations will be specifically described using FIG. 5.

It is now assumed that the test pattern generation unit 113 selects the state change “0→1” of the signal A. The test pattern generation unit 113 combines the state change “0→1” of the signal. A with the states or state changes of the other signal B. That is, the test pattern generation unit 113 comprehensively generates combinations of the state change “0→1” of the signal A and the states “0” and “1” possibly taken by the signal B and the state changes “0→1” and “1→0” possibly taken by the signal B. Here, the four combinations shown in FIG. 5 are generated.

Similarly, the test pattern generation unit 113 also generates combinations (test patterns) of the state change “1→0” of the signal A, the state change “0→1” of the signal B, and the state change “1→0” of the signal B and the states or state changes of the other signal.

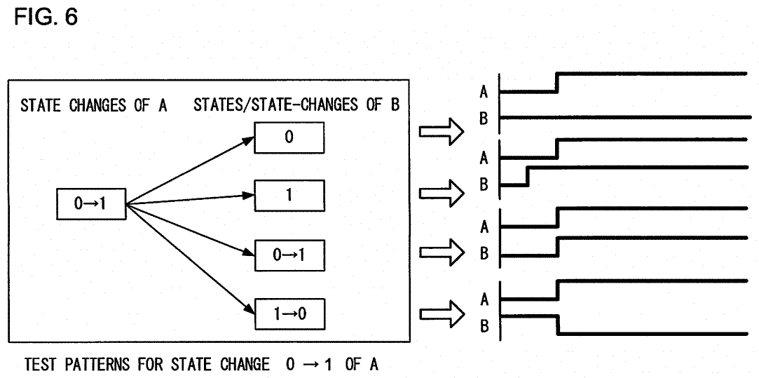

The test input sequence generation unit 114 generates test input sequences on the basis of the combinations (test patterns) generated by the test pattern generation unit 113. The generation of the test input sequences will be specifically described using FIG. 6.

The test input sequence generation unit 114 selects one of the input signals extracted by the input signal retention unit 111 and generates respective test input sequences corresponding to combinations (test patterns) of a state change of the selected signal and the states or state changes of the other signal. For example, attention is paid to the state change “0→1” of the signal A. With respect to a combination of the state change “0→1” of the signal A and the state “0” of the signal B, the test input sequence generation unit 114 generates a test input sequence in which the signal B is maintained at 0 while the state of the signal A changes from 0 to 1. With respect to a combination of the state change “0→1” of the signal A and the state “1” of the signal B, the test input sequence generation unit 114 generates a test input sequence in which the signal B is maintained at 1 while the state of the signal A changes from 0 to 1. With respect to a combination of the state change “0→1” of the signal A and the state change “0→1” of the signal B, the test input sequence generation unit 114 generates a test input sequence in which the signal B simultaneously changes from 0 to 1 when the state of the signal A changes from 0 to 1. With respect to a combination of the state change “0→1” of the signal A and the state change “1→0” of the signal B, the test input sequence generation unit 114 generates a test input sequence in which the signal B simultaneously changes from 1 to 0 when the state of the signal A changes from 0 to 1.

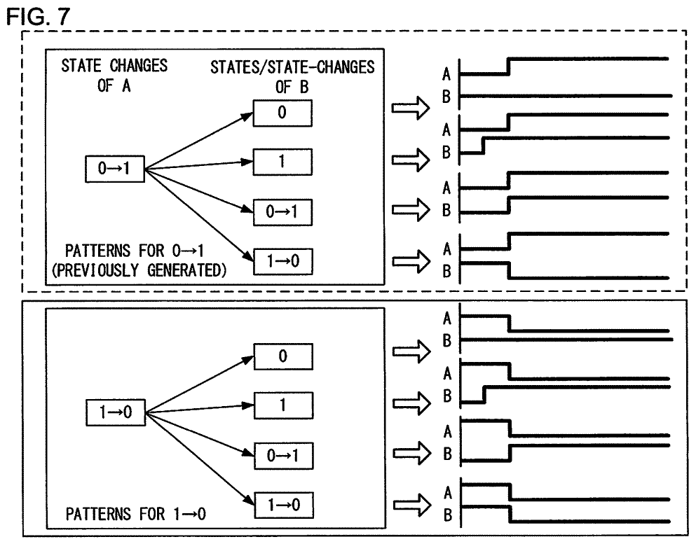

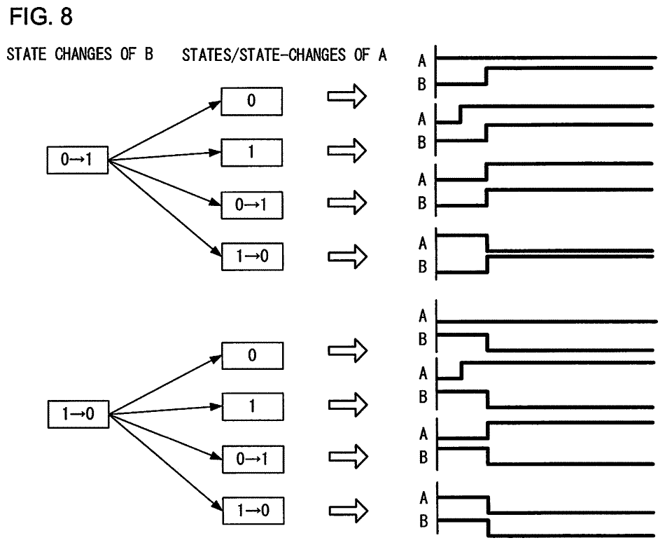

Similarly, the test input sequence generation unit 114 repeatedly performs the processing to generate test input sequences with respect to the other state change of the selected signal. As shown in, for example, FIG. 7, the test input sequence generation unit 114 generates test input sequences corresponding to combinations (test patterns) of the state change “1→0” of the signal A and the states or state changes of the other signal. The test input sequence generation unit 114 also repeatedly performs the processing to generate test input sequences with respect to the respective state changes of the other signal. As shown in, for example, FIG. 8, the test input sequence generation unit 114 also generates test input sequences corresponding to combinations (test patterns) of the state change “0→1” of the signal B and the states or state changes of the other signal and test input sequences corresponding to combinations (test patterns) of the state change “1→0” of the signal B and the states or state changes of the other signal.

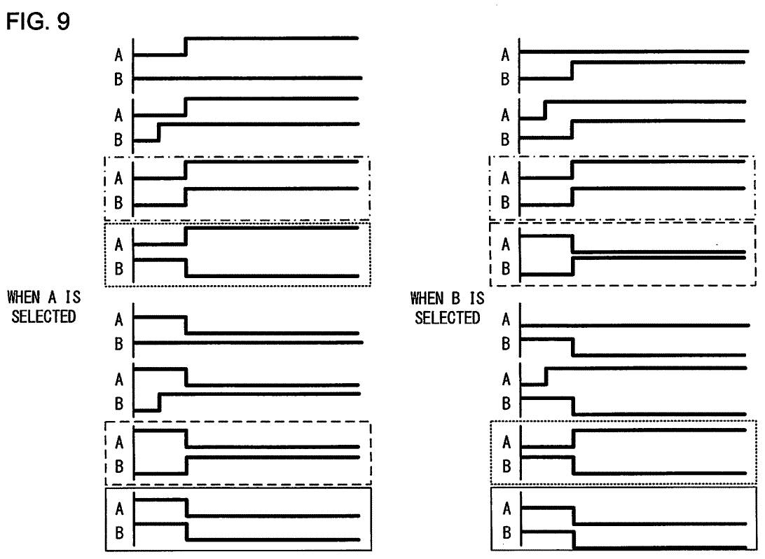

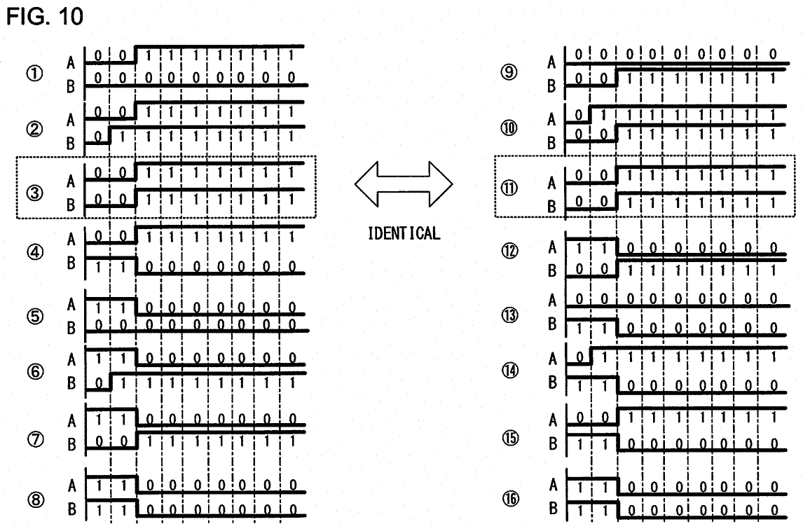

The test input sequence reduction unit 115 finds out the identical patterns from all the test input sequences generated by the test input sequence generation unit 114 and puts the found-out patterns together into one pattern. In, for example, FIG. 9, the test input sequence reduction unit 115 may find out four paired identical test input sequences, eight test input sequences in total. The test input sequence reduction unit 115 deletes one test input sequence and leaves only the other in each of the paired test input sequences. The deletion of the test input sequences will be specifically described using FIG. 10.

The test input sequence reduction unit 115 converts all the test input sequences generated by the test input sequence generation unit 114 into bit strings. That is, the test input sequence reduction unit 115 divides the respective input signals of the test input sequences into a prescribed number of sections and outputs values of the input signals in the respective sections as numerical strings. By comparing the numerical strings with each other, the test input sequence reduction unit 115 may find out matching test input sequences.

The test processing device 120 has a test execution unit 121 and a test result display unit 122.

The test execution unit 121 executes a test on the sequence program using the test input sequences generated by the test pattern generation device 110. Since a method for executing the test is a known technology, its detailed description will be omitted here.

The test result display unit 122 displays results of tests executed by the test execution unit 121 on a display or the like.

A ladder execution unit 301 of a numerical controller (CNC) 3 reads and analyzes the ladder program generated by the ladder editing device 2 and executes the ladder program.

According to the present embodiment, the test pattern generation device 110 may efficiently generate the test input sequences with attention paid to the state changes of the signals. For example, according to a conventional method, the number of test patterns is the n-th power of 4 when each of the signals A and B takes either 0 or 1. When the number of scans is 5, 1024 (=the 5th power of 4) test patterns are required, which takes enormous trouble. Meanwhile, according to the present embodiment, it is possible to execute a comprehensive test using only the 12 patterns shown in FIG. 9 with attention paid to the state changes. Thus, it is possible to remarkably reduce the number of steps required to execute the test on the sequence programs.

### Another Embodiment (1)

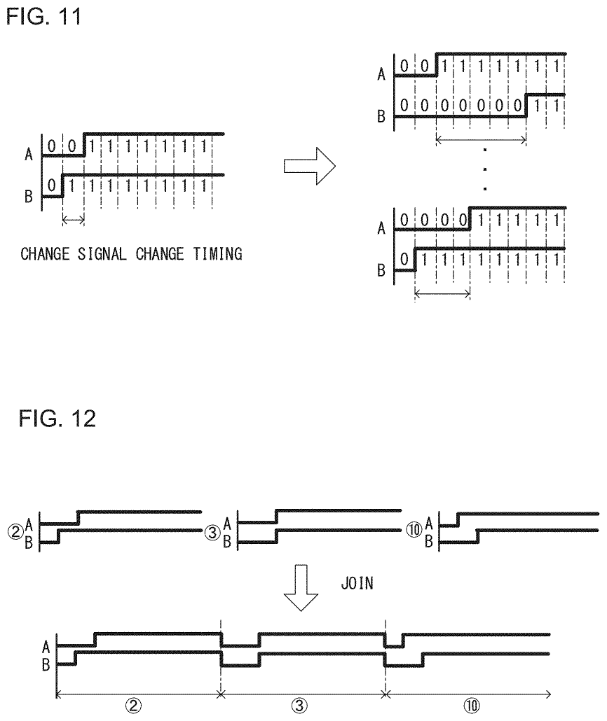

The test input sequence generation unit 114 may generate test input sequences having more abundant variations by shifting timings at which the signals change on the basis of the test input sequences generated in the above embodiment. The generation of the test input sequences will be specifically described using FIG. 11.

The left part of FIG. 11 shows one of the test input sequences generated by the test input sequence generation unit 114 according to the method described in the above embodiment. According to the present embodiment, the test input sequence generation unit 114 additionally generates test input sequences by shifting a timing at which the signal A changes from 0 to 1 or a timing at which the signal B changes from 0 to 1. The upper right part of FIG. 11 shows an example in which a time at which the signal B changes from 0 to 1 is delayed. The lower right part of FIG. 11 shows an example in which a time at which the signal A changes from 0 to 1 is delayed.

The test input sequence reduction unit 115 may also find out identical patterns from the test input sequences additionally generated by the test input sequence generation unit 114 and put the found-out patterns together into one pattern.

### Another Embodiment (2)

The test input sequence generation unit 114 may additionally generate test input sequences by joining together m of the test input sequences. Here, m is any integer of 2 or more and N or less, where N is the number of the test input sequences generated by the test input sequence generation unit 114. The additional generation of the test input sequences will be specifically described using FIG. 12.

The upper part of FIG. 12 shows three test input sequences (m=3) generated by the test input sequence generation unit 114 according to the method described in the above embodiment. The test input sequence generation unit 114 may generate one additional test input sequence by joining the test input sequences together in series in terms of time. Further, the test input sequence generation unit 114 may additionally generate another test input sequence by changing the joining order of the test input sequences.

### Another Embodiment (3)

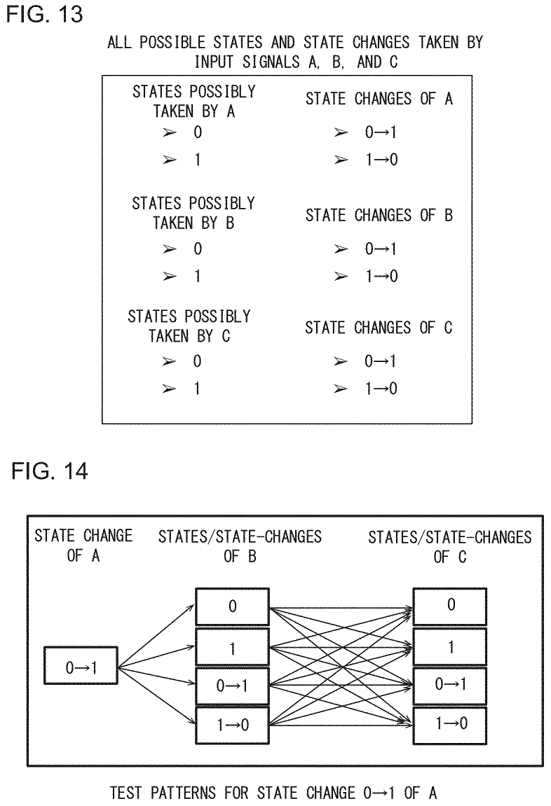

There may be three or more input signals with respect to a sequence program. The operation of the test equipment 1 in a case in which there are three input signals will be described as an example using FIGS. 13 to 20.

The state/state-change analysis unit 112 calculates all possible states (values) and state changes for each of the input signals extracted by the input signal retention unit 111. The calculation of the states and state changes of the input signals will be specifically described using FIG. 13.

It is now assumed that there are three input signals A, B, and C with respect to a sequence program, and that all the input signals possibly take either 0 or 1. In this case, the signal A possibly takes one of two states, i.e., 0 or 1, the signal B possibly takes one of two states, i.e., 0 or 1, and the signal C possibly takes one of two states, i.e., 0 or 1. Further, the signal A possibly changes to 1 when the state of the signal A is 0, and possibly changes to 0 when the state of the signal A is 1. These are the possible two state changes taken by the signal A. The signal B also possibly changes to 1 when the state of the signal B is 0, and possibly changes to 0 when the state of the signal B is 1. These are the possible two state changes taken by the signal B. The signal C also possibly changes to 1 when the state of the signal C is 0, and possibly changes to 0 when the state of the signal C is 1. These are the possible two state changes taken by the signal C.

The test pattern generation unit 113 selects one of the input signals extracted by the input signal retention unit 111 and generates combinations (test patterns) of a state change of the selected signal and the states or state changes of the other signals. The generation of the combinations will be specifically described using FIG. 14.

It is now assumed that the test pattern generation unit 113 selects the state change “0→1” of the signal final A. The test pattern generation unit 113 combines the state change “0→1” of the signal A with the states or state changes of the other signals B and C. That is, the test pattern generation unit 113 comprehensively generates combinations of the state change “0→1” of the signal A and the states “0” and “1” possibly taken by the signal B and the state changes “0→1” and “1→0” possibly taken by the signal B. In addition, the test pattern generation unit 113 comprehensively generates combinations of the states and state changes possibly taken by the signal B and the states “0” and “1” possibly taken by the signal C and the state changes “0→1” and “1→0” possibly taken by the signal C. As a result, the 16 combinations shown in FIG. 14 are generated.

Similarly, the test pattern generation unit 113 also generates combinations (test patterns) of the state change “1→0” of the signal A, the state change “0→1” of the signal B, the state change “1→0” of the signal B, the state change “0→1” of the signal C, and the state change “1→0” of the signal C and the states or state changes of the other signals.

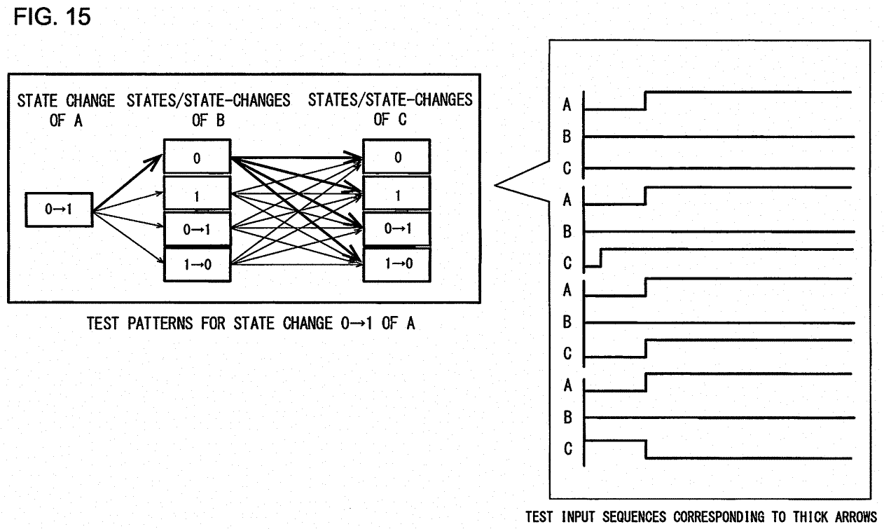

The test input sequence generation unit 114 generates test input sequences on the basis of the combinations (test patterns) generated by the test pattern generation unit 113. The generation of the test input sequences will be specifically described using FIG. 15.

The test input sequence generation unit 114 selects one of the input signals extracted by the input signal retention unit 111 and generates respective test input sequences corresponding to combinations (test patterns) of a state change of the selected signal and the states or state changes of the other signals. FIG. 15 illustrates, as an example, processing to generate test input sequences corresponding to the combinations indicated by thick arrows. First, the test input sequence generation unit 114 pays attention to the state change “0→1” of the signal A. With respect to a combination of the state change “0→1” of the signal A, the state “0” of the signal B, and the state “0” of the signal C, the test input sequence generation unit 114 generates a test input sequence in which the signal B and the signal C are maintained at 0 while the state of the signal A changes from 0 to 1. With respect to a combination of the state change “0→1” of the signal A, the state “0” of the signal B, and the state “1” of the signal C, the test input sequence generation unit 114 generates a test input sequence in which the signal B is maintained at 0 and the signal C is maintained at 1 while the state of the signal A changes from 0 to 1. With respect to a combination of the state change “0→1” of the signal A, the state “0” of the signal B, and the state change “0→1” of the signal C, the test input sequence generation unit 114 generates a test input sequence in which the signal B is maintained at 0 and the signal C simultaneously changes from 0 to 1 when the state of the signal A changes from 0 to 1. With respect to a combination of the state change “0→1” of the signal A, the state “0” of the signal B, and the state change “1→0” of the signal C, the test input sequence generation unit 114 generates a test input sequence in which the signal B is maintained at 0 and the signal C simultaneously changes from 1 to 0 when the state of the signal A changes from 0 to 1.

Similarly, the test input sequence generation unit 114 repeatedly performs the processing to generate test input sequences corresponding to cases in which the state of the signal B is “1” and the state changes of the signal B are “0→1” and “1→0.” That is, the test input sequence generation unit 114 generates test input sequences with respect to all the 16 combinations shown in FIG. 15.

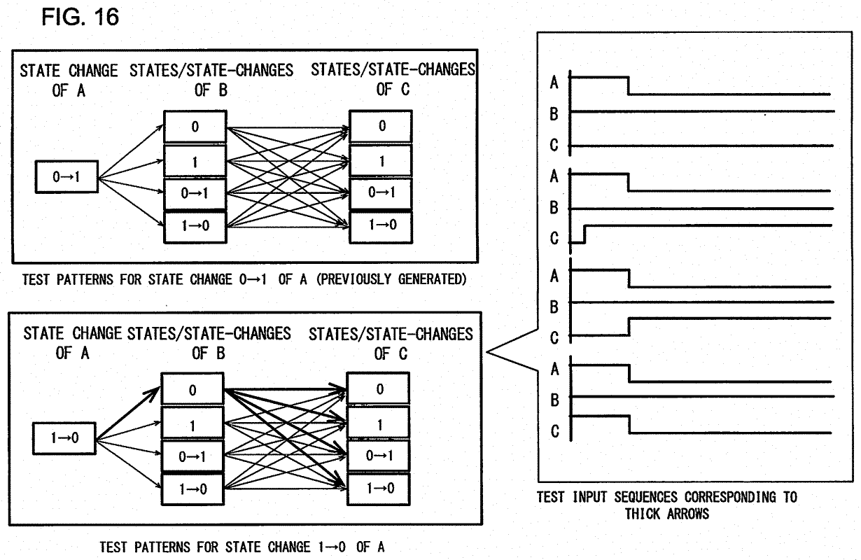

The test input sequence generation unit 114 repeatedly performs the processing to generate test input sequences with respect to the other state change of the selected signal. As shown in, for example, FIG. 16, the test input sequence generation unit 114 generates 16 test input sequences corresponding to combinations (test patterns) of the state change “1→0” of the selected signal A and the states or state changes of the other signals.

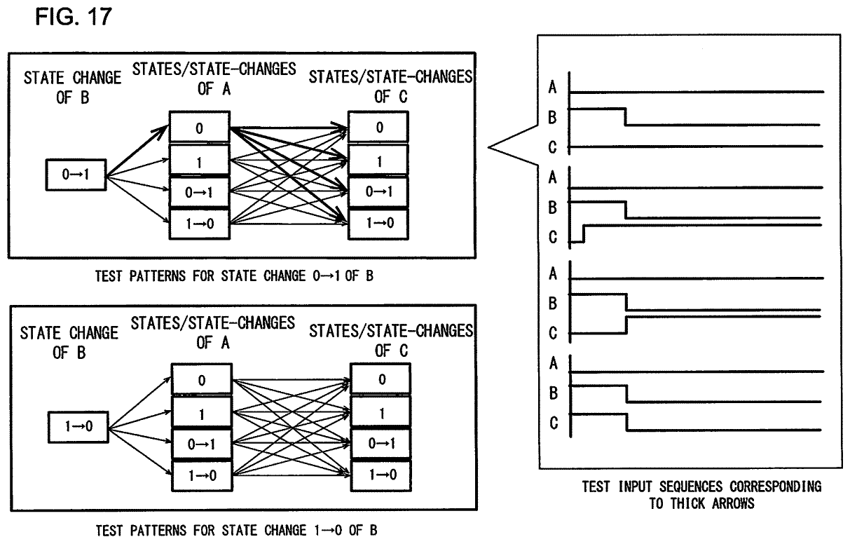

The test input sequence generation unit 114 also repeatedly performs the processing to generate test input sequences with respect to the respective state changes of the other signals. As shown in, for example, FIG. 17, the test input sequence generation unit 114 generates 32 test input sequences corresponding to combinations (test patterns) of the state change “0→1” of the signal B and the states or state changes of the signals A and C and combinations (test patterns) of the state change “1→0” of the signal B and the states or state changes of the signals A and C. Similarly, the test input sequence generation unit 114 also generates 32 test input sequences corresponding to combinations (test patterns) of the state change “0→1” of the signal C and the states or state changes of the signals A and B and combinations (test patterns) of the state change “1→0” of the signal C and the states or state changes of the signals A and B.

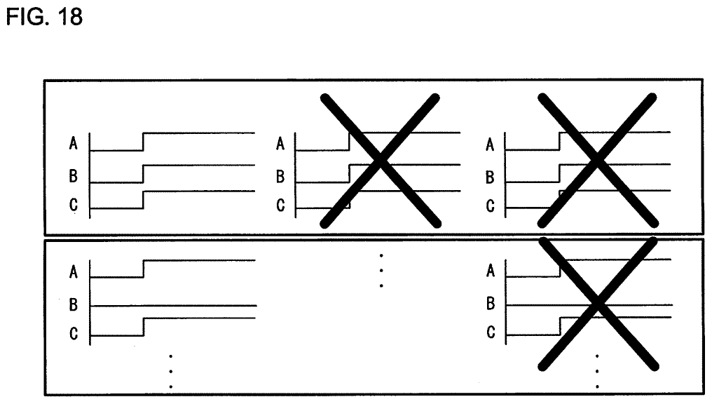

The test input sequence reduction unit 115 finds out identical patterns from all the test input sequences generated by the test input sequence generation unit 114 and puts the found-out patterns together. As shown in FIG. 18, the test input sequence reduction unit 115 leaves only one identical test input sequence and deletes the others in each of the identical patterns.

As an example, consideration will be given to processing in which identical patterns are put together into one pattern, with respect to the test input sequences generated under the conditions shown in FIG. 13. In this case, 96 test patterns are generated. Among the test patterns, the number of cases in which the identical test patterns are generated are as follows.

The number of cases in which three identical test patterns are generated: 8

In a pattern in which three signals change simultaneously, three identical test patterns are generated as shown in the upper part of FIG. 18. In this case, it is possible to delete two patterns in each case. As a result, 2×8=16 patterns are deleted in total.

The number of cases in which two identical test patterns are generated: 24

In a pattern in which two signals change simultaneously, two identical test patterns are generated as shown in the lower part of FIG. 18. In this case, it is possible to delete one pattern in each case. As a result, 1×24=24 patterns are deleted.

Accordingly, 96−16−24=56 patterns are left after the deletion.

Specifically, as shown in FIG. 10, the test input sequence reduction unit 115 converts all the test input sequences generated by the test input sequence generation unit 114 into bit strings. That is, the test input sequence reduction unit 115 divides the respective input signals of the test input sequences into a prescribed number of sections and outputs values of the input signals in the respective sections as numerical strings. By comparing the numerical strings with each other, the test input sequence reduction unit 115 may find out matching test input sequences.

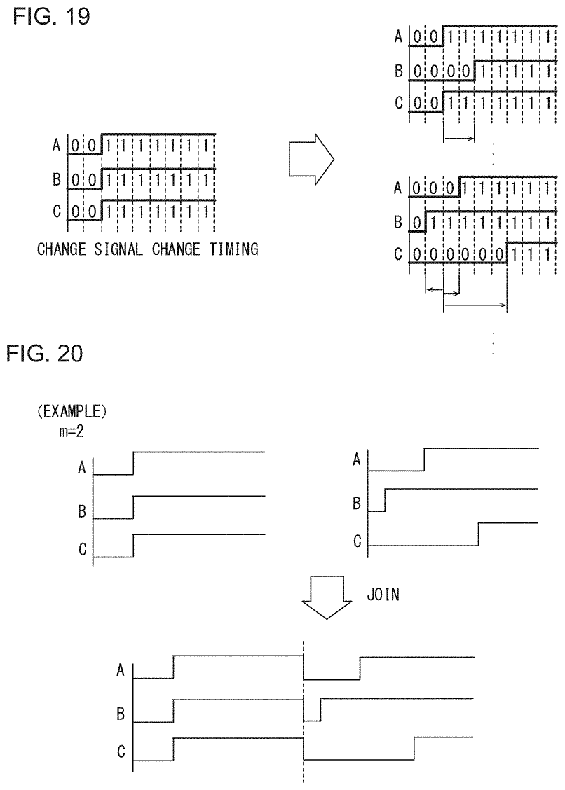

Note that in the present embodiment as well, the test input sequence generation unit 114 may generate test input sequences having more abundant variations by shifting timings at which the signals change on the basis of the test input sequences generated by the method according to the present embodiment. The generation of the test input sequences will be specifically described using FIG. 19.

The left part of FIG. 19 shows one of the test input sequences generated by the test input sequence generation unit 114. The test input sequence generation unit 114 may additionally generate test input sequences by shifting a timing at which the signal A changes from 0 to 1, a timing at which the signal B changes from 0 to 1, and a timing at which the signal C changes from 0 to 1. The upper right part of FIG. 19 shows an example in which a time at which the signal B changes from 0 to 1 is delayed. The lower right part of FIG. 19 shows an example in which a time at which the signal A changes from 0 to 1 is delayed, a time at which the signal B changes from 0 to 1 is advanced, and a time at which the signal C changes from 0 to 1 is delayed.

The test input sequence reduction unit 115 may also find out identical patterns from the test input sequences additionally generated by the test input sequence generation unit 114 and put the found-out patterns together into one pattern.

Further, in the present embodiment as well, the test input sequence generation unit 114 may additionally generate test input sequences by joining m of the generated test input sequences together. Here, m is any integer of 2 or more and N or less, where N is the number of the test input sequences generated by the test input sequence generation unit 114. The additional generation of the test input sequences will be specifically described using FIG. 20.

The upper part of FIG. 20 shows two test input sequences (m=2) generated by the test input sequence generation unit 114. The test input sequence generation unit 114 may generate one additional test input sequence as shown in the lower part of FIG. 20 by joining the test input sequences together in series in terms of time. Further, the test input sequence generation unit 114 may additionally generate another test input sequence by changing the joining order of the test input sequences.

Note that the present invention is not limited to the above embodiments but may be appropriately modified without departing from the spirit of the present invention.

1. A test pattern generation device that generates test input sequences for testing a sequence program, the test pattern generation device comprising:
a state/state-change analysis unit that calculates all possible states and state changes taken for each of input signals of the sequence program;
a test pattern generation unit that generates test patterns in which each of the state changes of the input signals is combined with the states or the state changes of another of the input signals; and
a test input sequence generation unit that generates the test input sequences on a basis of the test patterns.

2. The test pattern generation device according to claim 1, further comprising:
a test input sequence reduction unit that deletes an overlapping test input sequence from the test input sequences.

3. The test pattern generation device according to claim 1, wherein
the test input sequence generation unit generates additional test input sequences by shifting a signal change timing of the generated test input sequences.

4. The test pattern generation device according to claim 1, wherein
the test input sequence generation unit generates additional test input sequences by joining a plurality of the generated test input sequences together.
